(19) United States
(12) Patent Application Publication
(10) Pub. No.: US 2025/0384709 A1
(43) Pub. Date: Dec. 18, 2025

(54) SYSTEM AND METHOD FOR ADAPTIVE DATA PROCESSING

(71) Applicants: Abhinand Chincholi, Cave Creek, AZ (US); Vinamra Mattoo, Bangalore (IN)

(72) Inventors: Abhinand Chincholi, Cave Creek, AZ (US); Vinamra Mattoo, Bangalore (IN)

(21) Appl. No.: 18/744,938

(22) Filed: Jun. 17, 2024

(51) Int. Cl. G06V 30/416; G06V 30/16; G06V 30/413

(52) U.S. Cl. CPC G06V 30/416; G06V 30/16; G06V 30/413

(57) ABSTRACT

A method for artificial intelligence document processing includes receiving at least one document. The method includes performing preprocessing on at least one document to form at least one pre-processed document. The method includes analyzing, utilizing an optical character recognition module, the at least one pre-processed document to retrieve at least one data element from the at least one pre-processed document. The method also includes classifying, utilizing a first machine learning language model, the at least one pre-processed document based on the at least one data element. Further, the method includes determining, utilizing a second machine learning language model, at least one extraction detail for the at least one pre-processed document. The method includes validating, by a validator model, the at least one structured data element. Also, the method includes transmitting, to a datastore, the structured data element, in response to validation.

### FIELD

The present disclosure relates to data processing and, more particularly, to an Artificial Intelligence powered system and method for adaptive document processing.

### BACKGROUND

The submission of educational transcripts is typically a requirement when students apply for post-secondary education. Every semester, admissions teams at secondary and post-secondary educational institutions struggle to manually process educational transcripts for prospective students. This is because educational transcripts come in an innumerable variety of formats and are not standardized across all educational institutions. Manual processing of transcripts is disadvantageous because it introduces the element of human error and can cause large delays in the application processing timeline.

As can be seen, there is a need for an artificial intelligence powered system that can adapt to any format of educational transcript and process with accuracy.

### SUMMARY DISCLOSURE

In one aspect of the present disclosure, a method for Artificial Intelligence document processing includes receiving at least one document. The document includes at least one page. The method includes performing preprocessing on at least one document to form at least one pre-processed document. The method includes analyzing, utilizing an optical character recognition module, the at least one pre-processed document to retrieve at least one data element from the at least one pre-processed document. The method also includes classifying, utilizing a first machine learning language model, the at least one pre-processed document based on the at least one data element. Further, the method includes determining, utilizing a second machine learning language model, at least one extraction detail for the at least one pre-processed document. The at least one extraction detail is configured to extract the at least one data element into at least one structured data element. The method includes validating, by a validator model, the at least one structured data element. Also, the method includes transmitting, to a datastore, the structured data element, in response to validation.

These and other features, aspects and advantages of the present disclosure will become better understood with reference to the following drawings, description, and claims.

### BRIEF DESCRIPTION OF THE DRAWINGS

FIG. 1 is a block diagram of an overview of an embodiment of an AI transcript processing system, according to aspects of the present disclosure;

FIG. 2 is a block diagram of an embodiment of an architecture of an AI transcription processing system, according to aspects of the present disclosure;

FIG. 3 is a first portion of a flow diagram of an embodiment of AI transcript processing, according to aspects of the present disclosure; and

FIG. 4 is a second portion of a flow diagram of an embodiment of AI transcript processing, according to aspects of the present disclosure.

### DETAILED DESCRIPTION DISCLOSURE

The following detailed description is of the best currently contemplated modes of carrying out exemplary embodiments of the disclosure. The description is not to be taken in a limiting sense but is made merely for the purpose of illustrating the general principles of the disclosure, since the scope of the disclosure is best defined by the appended claims.

Broadly, one embodiment of the present disclosure is an artificial intelligence (AI) system and method for processing educational transcripts regardless of format, language, layout, etc. The system and method employ a Large Language Model (LLM) trained to understand educational transcripts of all trained languages, formats, layouts, etc. The AI system receives at least one document and performs preprocessing on the document. The preprocessing can involve correcting the orientation of the document, splitting the document into multiple files, converting pages to images, converting the document to greyscale, and merging the images into a single document. The pre-processed document is then analyzed using an optical character recognition (OCR) module to retrieve data elements. Multiple AI systems then proceed to classify the document as valid or invalid and also detect the origin location, language and other metadata from the transcript. The first Gen AI module then extracts all required details, and the second Gen AI module further converts the data into structured elements. These structured elements are validated by a validator module before being transmitted to a datastore upon successful validation. Advantageously, the system and method reduce transcript processing time, and errors associated with manual transcript processing.

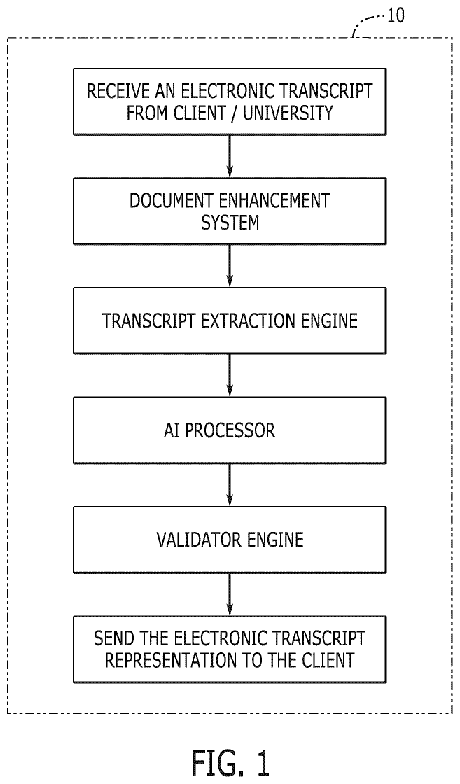

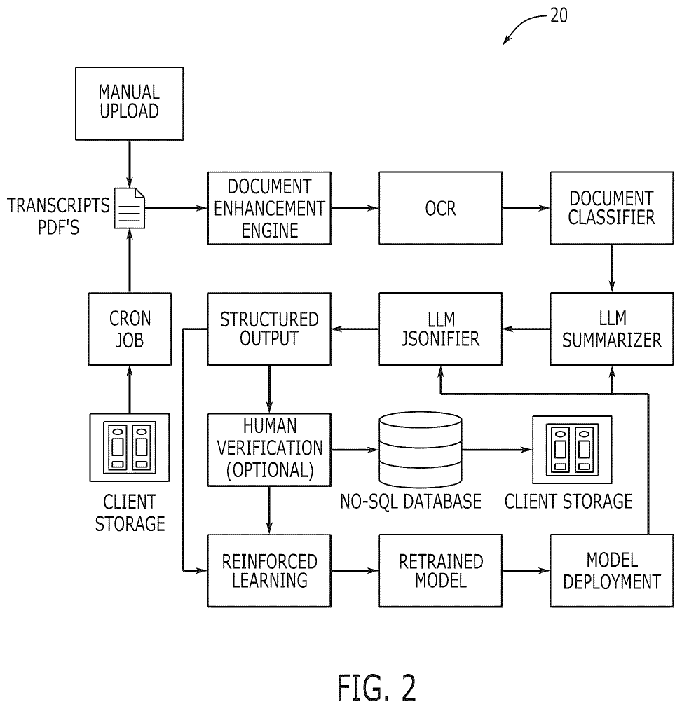

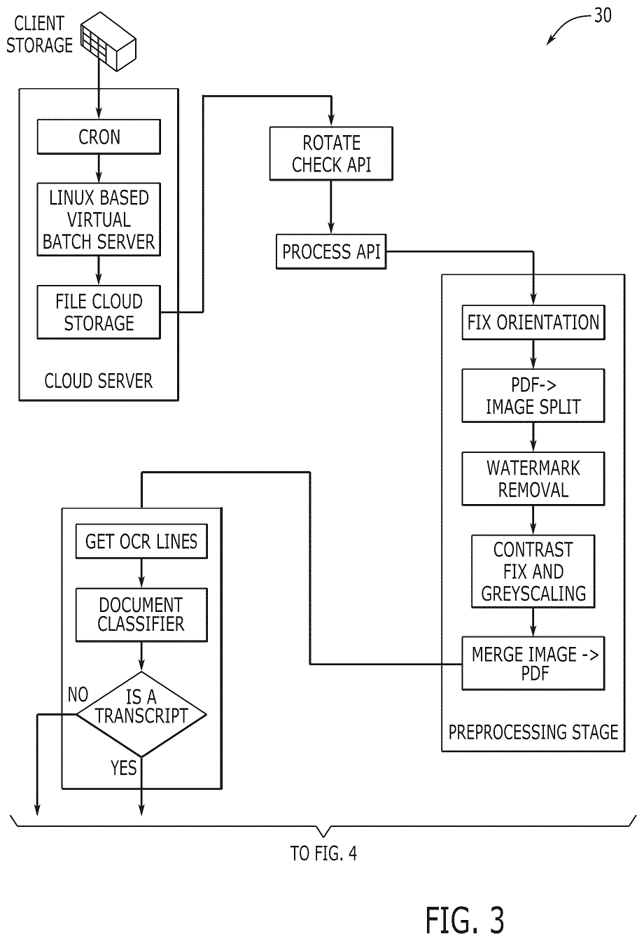

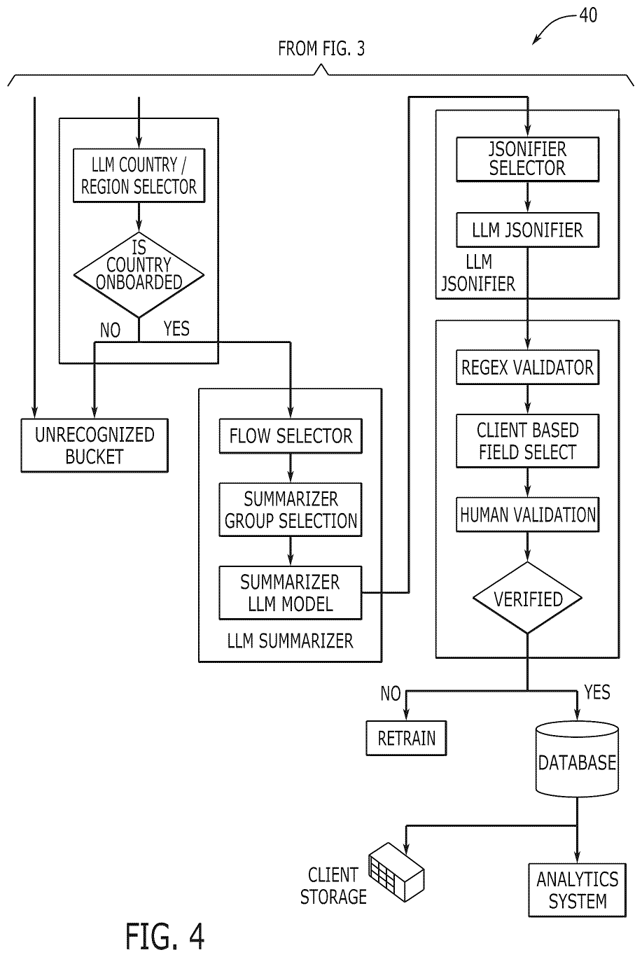

Referring to FIGS. 1 and 2, an overview of an embodiment of a flow of an AI-powered document processing system is illustrated, with further details provided in FIGS. 3 and 4. As an initial matter, AI-powered system 10 can retrieve, or otherwise receive, one or more documents, for a user, to be processed and the information contained in the document is extracted. In embodiment, the documents include educational transcripts, from any level and any country or jurisdiction. For example, the documents can be extracted from a client's, such as an educational institution's datastore. In embodiment, the documents can be retrieved, or otherwise received, utilizing one of a variety of mechanisms such as secure file transfer protocol (SFTP), application programming interface calls (API), etc. In embodiments, system 10 can provide middleware, or integrations, to pull data from known customer relationship management (“CRM”) software. Once retrieved, at least one document can be stored by system 10 for further processing. Advantageously, the diverse array of options for retrieval of the documents ensures effective and secure access to various sources, providing flexibility and convenience in document retrieval.

Once at least one document is retrieved by system 10, processing can begin. For example, as illustrated in FIG. 3, retrieval and processing of one or more documents can be executed in bulk through a job scheduling function. In embodiments, the job scheduling function can be a Unix/Linux based scheduling function, such as the cron function. Once received, the documents can be stored in a remote storage, for example, cloud storage. For instance, documents are picked up one by one (UI Dashboard) or in bulk using a cron based job (in case of batch processing) and sent to the main cloud server of system 10. The main cloud server of system 10 is in turn connected to multiple microservices that provide required functionalities using API calls. Advantageously, bulk processing ensures streamlined and time-effective processing of data.

After the documents are retrieved, preprocessing can be performed on the documents by passing the documents through a document enhancement system of system 10. The document enhancement system performs pre-processing of the documents to facilitate proper handling of at least one document. For example, as illustrated in FIG. 3, the document enhancement system can evaluate and correct an orientation of at least one document to ensure the at least one document is optimally positioned for precise processing by the system 10. Additionally, the document enhancement system can improve the quality of the documents by removing watermarks, adjusting any greyscale, and/or refining a contrast, which can result in a clearer image of the documents.

For instance, an API call is made to the Document Enhancement Engine, which first checks for the orientation of the given document, if the rotation is not appropriate it might cause errors at the time of text extraction and hence the rotation of the document is fixed based on the output of the rotation check function. This engine executes a series of actions to enhance the quality of the transcripts. The PDF transcript is split into individual pages, these pages are saved in image format. At this stage, each image is taken through multiple steps to increase its OCR readability. These steps involve simultaneous processing of each image on parallel threads, and an internal loop is executed on every individual pixel, invoking a function that analyzes the RGB values of each pixel. This function is employed to separate objects from the background in the image. Each pixel in the image is compared to a threshold value of 155. If the pixel's intensity exceeds this threshold, it is assigned a value of 255 (representing white) in the resulting image. Conversely, if the pixel's intensity is less than or equal to the threshold, it is categorized as part of the background and given a value of 0 (representing black) in the output image. This process effectively removes most watermarks and irregularities within the document. After completion, the document is converted to grayscale, and its contrast is adjusted to ensure easy readability for any OCR solution. The manipulation speed of image pixels is significantly accelerated by utilizing multiple cores from a GPU

Once pre-processing is complete, the documents can be passed to a transcript extraction engine of system 10. The transcript extraction engine can invoke an optical character recognition (OCR) module, which can be configured to capture data from the documents. For example, as illustrated in FIG. 3, OCR can be performed on each document to identify features of the documents. For example, cleaned up images from the pre-processing are then merged back into a single document and sent to the MultiLingual Optical Character Recognition (OCR) system, microservice as a base 64 encoding where after decoding the text, data is extracted from each page of the document along with the coordinates for each individual word present on the page. At this point the OCR might make mistakes with the ordering of the text due to slight skews or irregularities present in the document. To handle this scenario for each word, the central value is on the x axis. Based on its x1 and x3 coordinates are calculated. This is then repeated for all the words present in a page. Each central value is then checked with each other and if they fall within a given threshold, e.g., 40 pixels of one another it is assumed that the words lie in the same line. All the words are then assembled accordingly to get accurate OCR lines based on document layout.

Once identified, the transcript extraction engine can include logic to determine if document is transcripts to be further processed. If the logic of the transcript extraction engine determines that the document is a transcript, processing continues, whereas if it is determined that the document is not a transcript, the at least one document is categorized as “unrecognized”, and no further processing occurs on the at least one document. For example, the extracted OCR lines are then sent to a LLM based document classifier that checks if details that need to be extracted are present or not in the document. If the data is found to be lacking the document is classified as a non-transcript and sent to the unrecognized bucket. If all the required data is found the document is classified as a transcript and sent forward for further processing

As part of the classification, the system 10 can identify the country and/or region in which the document was generated. The identified country and/or region can then be used to select the trained LLM that matches the country and/or region. The AI processor module described below can maintain LLM that are trained for different languages. For example, the system 10 module passes the extracted raw text data through a LLM that checks and extracts the mentioned country or region inside the transcript. If the country/region is valid and currently under service then extraction details based on the country/region is picked up along with the client details from the database and passed down to the AI processor. Next, system 10 can apply each of the documents, classified as transcripts, to one or more machine learning algorithms in order to extract features and data from the documents. For example, as illustrated in FIG. 1, an AI processing module that includes one or more machine learning algorithms. As illustrated in FIGS. 3 and 4, for each document, the AI processing module can receive raw text from the output of the OCR module, from the transcript extraction engine, and organize extracted raw text into a structured format. In embodiments, structured formatting can be facilitated by incorporation of various models, which can culminate in standardized structured formatting such as, but not limited to, JSON, CSV, or XML formatting, of the at least one document. Advantageously, structured formatting improves coherence of data, and facilitates ease of processing.

For example, a Large Language Model Summarizer extracts specific details in a defined text format based on the predefined and editable settings from the Database that are selected by the clients beforehand. The Summarization step is taken to improve accuracy and can be skipped if the extracted details are simple in nature or if a more powerful and well fine tuned LLM model is being used. Once the client required data is highlighted and is in a well formatted structure another LLM system, the Large

Language Model Jsonifier comes into play and if the data is complex in nature, data loss might occur at this stage if the summarization step is skipped. The LLM Jsonifier takes in the structured data from the summarizer and converts into a JSON format with predefined keys, hence making it possible for it to be consumed through API's. The LLM sometimes may hallucinate and give out non JSON output thus another syntax checking function which checks if the data being generated is a proper JSON format with all the required fields is also required. Once the data is extracted in the JSON format multiple client specific business logics are applied on top of it to morph it into a suitable format that our customers can consume.

Upon completion of AI processing, a validator engine of system 10 can review the extracted data for accuracy. For example, as illustrated in FIG. 4, the validator engine can rely on customized logic such as, but not limited to, regular expressions, to ensure the precision of the extracted data. Upon completion of validation by the validator engine, transfer of at least one document to a client datastore is facilitated. In embodiments, the client datastore can be a CRM system, a Student information System, or a database, and transfer can be facilitated by APIs, middleware, or other functionality, tailored to the client datastore.

For example, as illustrated in FIG. 4, the output validator engine can pass each JSON element through an appropriate regular expression, or customized function, to validate that the element is in the proper format based. Advantageously, the output validator ensures the accuracy, integrity, and precision of elements when converted to JSON format.

After output validation, and optionally, the JSON formatted output can be passed to human experts for human review. In embodiments, human experts can forward erroneous data to a retraining pipeline to enhance accuracy of the system. Once this step is completed, data is published to client specific endpoints, such as client storage for further usage. In an exemplary embodiment, upon successful processing, the entirety of the output dataset is securely housed in a robust NoSQL database, ensuring streamlined storage and retrieval processes. Subsequently, the output data is provided in a custom format that can be published to the designated client storage systems, including widely used Customer Relationship Management (CRM) platforms and can be easily processed by the client. However, before sharing, the system 10 plays a critical role in safeguarding privacy and ensuring compliance with data protection regulations.

It should be understood, of course, that the foregoing relates to exemplary embodiments of the disclosure and that modifications may be made without departing from the spirit and scope of the disclosure as set forth in the following claims.

What is claimed is:

1. A document processing system, comprising:
at least one memory storing instructions, and
at least one processor configured to execute the instruction to perform a method comprising:
receiving at least one document, wherein the at least one document includes at least one page;
performing preprocessing on the at least one document to form at least one pre-processed document;
analyzing, utilizing an optical character recognition module, the at least one pre-processed document to retrieve at least one data element from the at least one pre-processed document;
classifying, utilizing a first machine learning language model, the at least one pre-processed document based on the at least one data element;
determining, utilizing a second machine learning language model, at least one extraction detail for the at least one pre-processed document, wherein the at least one extraction detail is configured to extract the at least one data element into at least one structured data element;
validating, by a validator model, the at least one structured data element; and
transmitting, to a datastore, the structured data element, in response to validation.

2. The system of claim 1, wherein preprocessing includes at least one of: correcting an orientation of the at least one document; splitting the at least one document into a plurality of files; converting the at least one page to at least one image; removing at least one watermark from the at least one document; converting the at least one document to greyscale; transforming the at least one page into at least one image; and merging the plurality of files into a document.

3. The system of claim 1, wherein the validator model includes regular expressions configured to validate the structured data element.

4. The system of claim 1, wherein performing the preprocessing, further comprising:
analyzing a pixel intensity of each pixel of the at least one document;
determining the pixel intensity is below a threshold;
in response to the determination, resetting the pixel intensity to 0.

5. The system of claim 1, further comprising:
retraining at least one of the first machine learning language model and the second machine learning language model, based on the at least one document.

6. The system of claim 1, the at least one document is an educational transcript.

7. A method for Artificial Intelligence document processing, the method comprising:
receiving at least one document, wherein the at least one document includes at least one page;
performing preprocessing on the at least one document to form at least one pre-processed document;
analyzing, utilizing an optical character recognition module, the at least one pre-processed document to retrieve at least one data element from the at least one pre-processed document;
classifying, utilizing a first machine learning language model, the at least one pre-processed document based on the at least one data element;
determining, utilizing a second machine learning language model, at least one extraction detail for the at least one pre-processed document, wherein the at least one extraction detail is configured to extract the at least one data element into at least one structured data element;
validating, by a validator model, the at least one structured data element;
transmitting, to a datastore, the structured data element, in response to validation.
